(19) United States
(12) Patent Application Publication
(10) Pub. No.: US 2013/0015968 A1
(43) Pub. Date: Jan. 17, 2013

(54) SYSTEM AND METHOD OF ALARM INSTALLATION AND CONFIGURATION

(71) Applicant: DAVID WILLIAM BAIN HOGG, Falkirk (GB)

(72) Inventor: DAVID WILLIAM BAIN HOGG, Falkirk (GB)

(73) Assignee: HONEYWELL INTERNATIONAL INC., Morristown, NJ (US)

(21) Appl. No.: 13/182,074

(22) Filed: Jul. 13, 2011

(51) Int. Cl. G08B 19/00; G08B 21/00

(52) U.S. Cl. 340/521; 340/540

(57) ABSTRACT

An installation support system includes a smart phone which executes a downloaded installation application. An installer can create a visual map of a virtual region, corresponding to a portion of a monitored space. One or more units being installed can be associated with locations in the virtual region. Identification tags for the units can be located throughout the virtual region. A representation of the virtual region can be stored for later retrieval and use.

### FIELD

The application pertains to systems and methods to facilitate installation of regional monitoring systems. More particularly, the application pertains to such systems and methods usable in the installation of some or all of the units, sensors, or detectors distributed through a region being monitored.

### BACKGROUND

When installing an alarm system, it can be difficult to get a map of the locations where the distributed devices, such as condition detectors, or sensors are located.

The problem is compounded for wireless monitoring systems, an increasing population, as the detectors, or sensors, cannot be traced back to a specific hard wired bus device. It can also be tedious and error prone for an installer to have to manually take notes on the locations of the devices.

### BRIEF DESCRIPTION OF THE DRAWING

FIG. 1 is a block diagram of a system in accordance herewith.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

Moving from manually created maps to maps created, at least in part with interactive communications devices can be expected to promote accuracy and increase installer productivity. In one aspect, using a smart phone and an associated software application to record device placement and device parameters, and any other relevant information, can make the documentation creation process easier and more efficient. Additionally, systems with better over-all documentation should be easier to maintain.

In accordance with the present system and method, using a cellular-type communications device for example, a smart phone, an installer can easily create a virtual map of the environment in which an alarm unit is being installed, in a new or an existing monitoring system, as well as details of the installation itself. This map could then be used in conjunction with any previously existing physical, or electronic, building maps.

As discussed subsequently, the phone can record movement. For example, the recorded movements of the installer during the installation process can be used to create a virtual map of the building. That map can be annotated, in real-time during the installation process, by the installer as he/she moves from room to room, or area to area installing units, sensors, or detectors of a monitoring system.

Each new room can be assigned either a text or voice tag. Voice recognition software could convert voice tags to text. The movement could be detected by the onboard accelerometer. Alternately, a GPS system can be used. When installing specific device types, it will be possible to cross-reference other devices, in the case of hardwired detectors on a RIO, to the RIO to which they are going to be connected. Wireless, or RF devices, become easier to locate and maintain as they have specific locations that can be easily found.

The equipment ID mark, for example, a serial number, or other information which could be represented by a machine readable code, such as a barcode, or an optical code, can then be photographed. The location within the room recorded.

The bar code or optical, character, code can also be scanned and the recognized information can be loaded into the cell phone. The device type can be cross referenced in the system and can also be annotated, again by either a text or voice tag.

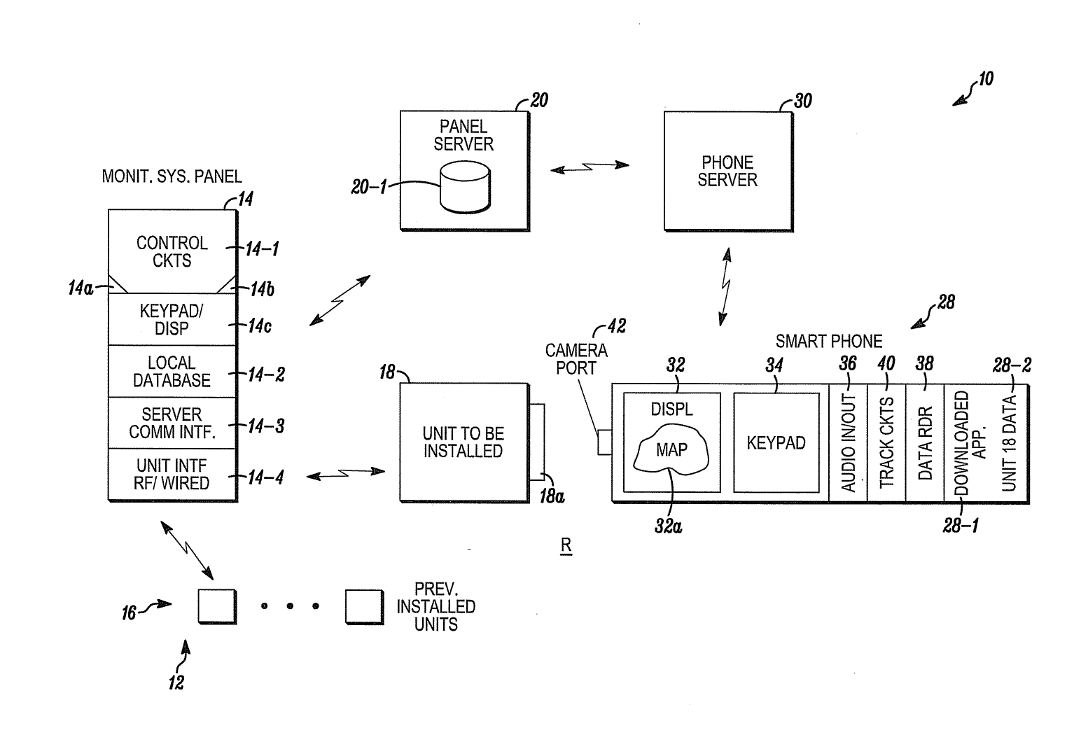

FIG. 1 illustrates a system 10 in accordance herewith. System 10 includes a regional monitoring system 12 which monitors events in a region R. System 12 includes a control element, or panel 14 which is in wireless communication with a plurality of sensors or detectors 16 which have previously been installed through the region R. Sensor or detectors 16 can include position detectors, movement detectors, glass breakage detectors, smoke detectors, fire detectors, or gas detectors, all without limitation.

Monitoring panel 14 can be implemented with control circuits 14-1, a local data base 14-2, an internet, or intranet communications interface 14-2 for communication with server 20, a unit interface 14-4 for wired or wireless communications with members of the plurality of previously installed units 16.

The control circuits 14-1 can be implemented, in part with one or more programmed processors 14a. The processors 14a execute pre-store control software 14b. The control circuits 14 can carry out bidirectional communications with the units 16 as well as the server 20 as would be understood by those of skill in the art.

As illustrated in FIG. 1, another detector, unit 18, is ready for installation. Unit 18 carries bar coded or character coded information 18a. The information 18a can include equipment identification information, serial number or other parametric information relative to the respective unit.

The monitoring system panel 14 can also be in wireless communication with the unit 18, when installed, and also can be in wireless communication with a server 20. Server 20 can include a database of information pertaining to the plurality of units 16, for use by the panel 14. The monitoring panel 14 thus has on-going access to the contents of database 20-1 and can update same in response to its communications with the units 16:

A smart phone 28 can be in wireless communication with a phone server 30. Smart phone 28 can download from the server 30 an installation support application 28-1. The application 28-1 can be stored for execution in circuitry at the phone 28.

The phone 28 carries peripheral devices such as a display 32, a keypad 34, audio input and output devices 36, a reader of bar codes or optical character codes 38, location tracking circuits 40 and a camera with a port 42. The phone 28 can be in communication with the monitoring panel 14 directly, via server 20 or via server 30, all without limitation.

When the unit 18 is to be installed, the installer can use the phone 28 to read the coded information 18a concerning the unit 18 and forward that information to be stored in database 20-1. Additionally, the installer via keypad 34 and audio input circuitry 36 enter the location of the unit 18 in the region R. A portion of the region R, in the vicinity of the location of unit 18 can be visually presented 32a on the display device 32 of the phone 28 for the installer to view and to annotate with audibly enter tags, or keypad entered tags. The tags can provide additional information for the monitoring panel 14 and can also be incorporated into an installation map of the region R as noted previously.

In summary, in a disclosed implementation the smart phone 28 can be used in combination with a downloaded application 28-1 that can automatically record the details of the installation and provide an electronic map which will facilitate the installation process. Additionally, when it is necessary to visit the site for maintenance, the electronic map will be able to indicate the location of the faulty device.

The electronic location information can be exported to a personal computer, or to the monitoring system control panel 14. Asset tracking can also be provided for the alarm installer or other personnel. This capability could be implemented using any smart phone, or smart device-type (for example a PDA), communications device. In another aspect, this functionality could be implemented by having a phone interface coupled to the monitoring system control panel. The configuration information can then be entered automatically using wireless technologies such as blue tooth, wifi, or a USB.

Further, as those of skill will understand, that parameters and other information concerning the detectors or sensors can be included in the on-line database 20-1 of installable products, maintained for example at server 20. The database 20-1 can be accessed via a barcode or optically readable code on or associated with the respective installable produce.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. An apparatus comprising:
at least one unit to monitor a selected condition; and
a communications device which has a user input interface and circuitry for storage of unit location information, the device also includes circuitry to track movement through a region.

2. An apparatus as in claim 1 where the circuitry to track movement through the region includes additional circuitry to combine unit location information with tracked movement.

3. An apparatus as in claim 2 which includes circuitry to display a map of at least a portion of the region along with unit location information.

4. An apparatus as in claim 3 which includes circuits to establish identifiers associated with at least some portions of the region.

5. An apparatus as in claim 4 where the identifiers comprise at least one of audible or visual tags.

6. An apparatus as in claim 5 which includes circuits to convert audible tags, to visual tags.

7. An apparatus as in claim 5 where the units each carry at least one machine readable identifier, and where the communications device can sense at least some portion of the respective identifiers.

8. An apparatus as in claim 7 comprising a data base containing at least some portion of the identifier for each type of installable unit.

9. An apparatus as in claim 8 where the communication device has an interface and circuitry to download unit information to at least one of, a regional monitoring system control unit, a local computer, or a displaced server.

10. An apparatus as in claim 5 where the communications device includes at least one of a movement sensor, or global positioning circuitry.

11. An apparatus as in claim 5 which includes circuits to generate a visually displayable map indicative of a portion of the installation region.

12. An apparatus as in claim 11 where the map generating circuits can display unit location and, tags associated therewith.

13. An apparatus as in claim 5 where the unit is selected from a class which includes at least location sensors, glass break sensors, motion detectors, smoke detectors, gas detectors, and fire detectors.

14. An apparatus as in claim 13 where the communications device can transmit unit related location information to a monitoring system control unit either, directly, or, via communications network.

15. An apparatus as in claim 8 where the communications device can transmit unit related location information to a monitoring system control unit either, directly, or, via communications network, and where the unit is selected from a class which includes at least location sensors, glass break sensors, motion detectors, smoke detectors, gas detectors, and fire detectors.

16. A method comprising:
creating a map of at least part of an installation region;
displaying the map visually, using an electronic display;
specifying a location on the displayed map where a unit of a monitoring system is being installed; and
incorporating an indicium of the installed unit on the display.

17. A method as in claim 16 which includes entering parametic information associated with a unit being installed.

18. A method as in claim 17 which includes entering parameters at least one of verbally, or, by keyboarding them.

19. A method as in claim 18 which includes overlaying the installation map on a regional map.

20. A method as in claim 19 which includes providing unit type and related installation information to a regional monitoring system.
